(19) United States
(12) Patent Application Publication
(10) Pub. No.: US 2026/0254039 A1
(43) Pub. Date: Aug. 27, 2026

(54) BATTERY PRESSURE RELIEF DEVICES, BATTERY CASE AND BATTERIES

(71) Applicant: HON HAI PRECISION INDUSTRY CO., LTD., New Taipei (TW)

(72) Inventors: Jong-Ru Rau, New Taipei (TW); Pung-Chang Ho, New Taipei (TW); Yu-Jun Chou, New Taipei (TW); Yu-Ti Sha, New Taipei (TW); Yin-Hao Lo, New Taipei (TW); Yang-Chuan Tsai, New Taipei (TW)

(21) Appl. No.: 19/243,736

(22) Filed: Jun. 20, 2025

(30) Foreign Application Priority Data
Feb. 27, 2025 (CN) 202520330975.4

(51) Int. Cl. H01M 50/325; H01M 50/308

(52) U.S. Cl. CPC H01M 50/325; H01M 50/308

(57) ABSTRACT

A battery pressure relief device includes a valve seat, a valve body and a spool, the valve seat is assembled and disassembled to connect to the valve body, a first pressure relief passage is opened in the valve seat, a second pressure relief passage is opened in the valve body, the first pressure relief passage is connected to the second pressure relief passage, the spool is provided in the second pressure relief passage and one end of the spool is connected to the valve body, and the other end of the spool is a free end, so that the end portion of the free end is pressed against or pulled away from the inner wall of the valve body when subjected to different axial external forces.

### REFERENCES

The present application claims priority to Chinese Application No. 202520330975.4 filed on Feb. 27, 2025.

### FIELD

The subject matter relates to the technical field of battery manufacturing, and in particular to a battery pressure relief device, a battery case and a battery.

### BACKGROUND

The continuous development of new energy and energy storage industries and other technological fields has promoted continuous innovation and progress in the field of batteries. Lithium-ion batteries have the advantages of safety, high efficiency, non-pollution, high specific energy, abundant raw materials, multiple cycles, long storage time, etc. Lithium-ion batteries are therefore widely used in portable electronic devices (e.g. cell phones), digital camcorders, and laptop computers. Lithium-ion batteries are also widely used in large and medium-sized electric devices, such as electric cars, electric bicycles, and power tools.

Due to the wide application of lithium-ion batteries, the requirements for the safety performance, cycle-life, and capacity of lithium-ion batteries are becoming higher. In the prior art, when a lithium-ion battery is formed, a large amount of gas is generated inside the lithium-ion battery, and if the gas cannot be discharged to the outside world in time, it will lead to expansion of the battery, which will affect the service life of the battery or lead to safety problems such as explosions.

### SUMMARY

The disclosure provides a battery pressure relief device, a battery case and a battery to solve the problem of Pressure Relief. When a lithium-ion battery is formed, a large amount of gas is generated inside the lithium-ion battery, and if these gases can be vented to the outside world in a timely manner. Avoiding negative impact on the service life of the battery due to battery expansion, or lead to explosion and other potential safety hazards.

Embodiments of the disclosure are realized in this way:

A battery pressure relief device for relieving pressure inside a battery. The battery pressure relief device includes a valve seat, a valve body and a spool. The valve seat is assembled and disassembled to connect to the valve body. The valve seat includes a first pressure relief passage, the valve body includes a second pressure relief passage. The first pressure relief passage is connected to the second pressure relief passage. The spool is disposed in the second pressure relief passage and the spool is connected to the valve body at one end, the other end of the spool is a free end so that the end portion of the free end is pressed against or pulled away from the inner wall of the valve body when subjected to different axial external forces.

In order to discharge the gas inside the battery to the outside world, the battery pressure relief device of the present disclosure is provided with a first pressure relief passage inside the valve seat and a second pressure relief passage inside the valve body. At the same time, a spool is provided in the second pressure relief passage, and the spool can swing relative to the valve body. When there is more gas in the battery, the pressure inside the battery is greater than the outside pressure, one end of the spool separates from the inner wall of the second pressure relief passage, and the gas inside the battery is discharged to the outside world through the first pressure relief passage and the second pressure relief passage. On the contrary, the spool closes the second pressure relief passage to avoid the outside air or dust from entering the inside of the battery, which affects the performance of the battery.

In a possible embodiment, the free end of the spool is pulled away from the inner wall of the valve body when a difference between a pressure inside the valve body and a pressure outside is greater than or equal to 1 atmosphere.

In a possible embodiment, the maximum radial distance of the free end pulled away from the inner wall of the valve body is at least 0.67 mm.

In one possible embodiment, the spool includes a flap, the flap includes a connecting segment and a sealing segment, the sealing segment is connected to and extends from the connecting segment. The connecting segment is pivotally coupled to the valve body, and the connecting segment rotatable with respect to the valve body, so as to oscillate the sealing segment to swing, to seal the second pressure relief passage or to move the sealing segment away from the second pressure relief passage.

In one possible embodiment, an end of the connecting segment pivotally connected to an inner wall or an outer wall of one side of the second pressure relief passage, and the sealing segment is pivotable relative to the inner wall of another side of the second pressure relief passage to seal the second pressure relief passage or to move the sealing segment away from the second pressure relief passage.

In a possible embodiment, the spool further includes a linkage member. The linkage member extends from a side of the connecting segment in a direction away from the first pressure relief passage. The linkage member forms a gap between one side of the linkage member away from the sealing segment and the valve body. The gap is connected to the second pressure relief passage.

In one possible embodiment, the valve seat includes a seat body and a support member mounted outside the seat body. The first pressure relief passage passes through the seat body and the support member. The seat body is connected to the valve body.

In one possible embodiment, the seat body includes a first seat and a second seat. The first seat and the second seat are disposed opposite to each other. An end of the support member is connected to the first seat, and the other end of the support member is connected to the second seat. The first seat is disposed on the side of the support member proximate to the second pressure relief passage. The second seat is disposed on the side of the support member remote from the second pressure relief passage. The first seat is detachably connected to the valve body.

Embodiments of the present disclosure also provide a battery case. The battery case includes a case body and a battery pressure relief device as described above. The battery pressure relief device is provided on the case body. The case body is provided with an exhaust port. A portion of the battery pressure relief device is threaded through the exhaust port into the interior of the case body and making the interior of the case body in communication with the first pressure relief passage and second pressure relief passage.

Embodiments of the present disclosure also provide a battery. The battery includes a battery case as described above and a battery assembly provided inside the battery case.

When the battery pressure relief device is used to relieve pressure inside the battery, On the one hand, the spool is provided in the second pressure relief passage, which not only allows the spool to separate the inner wall of the second pressure relief passage to exhaust the gas inside the battery to the outside world when it is necessary to relieve the pressure inside the battery, but also prevents the outside world from entering into the inside of the battery with air and dust. On the other hand, the valve seat and the valve body are removably connected to each other, enabling the valve seat and the valve body to be disassembled and then cleaned when it is necessary to clean the battery pressure relief device, increasing the reuse rate of the battery pressure relief device. Avoiding the problem that a large amount of gases generated by the battery during the formation of the battery are not discharged from the outside world in a timely manner. Avoiding negative impact on the service life of the battery due to battery expansion, or lead to explosion and other potential safety hazards.

### BRIEF DESCRIPTION OF THE DRAWINGS

In order to more clearly illustrate the technical solutions of the embodiments of the disclosure, the accompanying drawings in the embodiments will be briefly introduced below, and it should be understood that the following accompanying drawings only show certain embodiments of the disclosure, and therefore should not be regarded as a limitation of the scope, and for the person of ordinary skill in the field, other relevant accompanying drawings can be obtained according to these drawings without creative labor.

FIG. 1 shows a schematic view of a structure of a battery of an embodiment of the disclosure.

FIG. 2 shows a schematic view of a structure of a battery case of another embodiment of the disclosure.

FIG. 3 shows a decomposition schematic view of a battery pressure relief device of an embodiment of the disclosure.

FIG. 4 shows a schematic view of one configuration of a flap in the battery pressure relief device of FIG. 3.

FIG. 5 shows a schematic view of another construction of the flap in the battery pressure relief device of FIG. 3.

FIG. 6 shows a schematic view of the flap and a linkage member in the battery pressure relief device of FIG. 3.

FIG. 7 shows a view of another construction of the flap and the linkage member in the battery pressure relief device of FIG. 3.

FIG. 8 shows a schematic diagram of another construction of the flap and the linkage member in the battery pressure relief device of FIG. 3.

FIG. 9 shows a schematic view of another construction of the flap and the linkage member in the battery pressure relief device of FIG. 3.

FIG. 10 shows a cross-sectional schematic view of the battery pressure relief device of FIG. 3 when the battery pressure relief device is in a vented state.

FIG. 11 shows a schematic view of a portion of the structure of the battery pressure relief device of FIG. 3 when the battery pressure relief device is in a vented state.

FIG. 12 shows a cross-sectional schematic view of the battery pressure relief device of FIG. 3 when the battery pressure relief device is in a normal state.

FIG. 13 shows a schematic view of a portion of the structure of the battery pressure relief device of FIG. 3 when the battery pressure relief device is in a normal state.

### DESCRIPTION OF MAIN COMPONENT SYMBOLS

Battery pressure relief device, 100; valve seat, 10; first pressure relief passage, 11; seat body, 12; first seat, 121; second seat, 122; external thread, 123; connecting portion, 124; guiding portion, 125; support member, 13; valve body, 20; second pressure relief passage, 21; internal thread, 22; opening, 23; spool, 30; flap, 31; connecting segment, 311; sealing segment, 312; free end, 313; linkage member, 32; gap, 40; battery case, 200; case body, 210; cover, 211; exhaust port, 220; holding space, 230; battery, 300; battery assembly, 310; hole bottom surface, P1; first surface, P2; second surface, P3; first direction, X; second direction, Y.

The following specific embodiments will further illustrate the present disclosure in conjunction with the above accompanying drawings.

### DETAILED DESCRIPTION

The technical solutions in the embodiments of the disclosure will be clearly and completely described below in conjunction with the accompanying drawings in the embodiments of the disclosure, and it is clear that the described embodiments are only a part of the embodiments of the disclosure, and not all of the embodiments.

It should be noted that when an element is the to be “fixed” to another element, it may be directly on the other element or there may also be a centered element. When an element is the to be “attached” to another element, it may be directly attached to the other element or there may be both centered elements. When an element is considered to be “set on” another element, it may be set directly on the other element or there may be both centered elements. The terms “vertical,” “horizontal,” “left,” “right,” and similar expressions are used herein for illustrative purposes only. are used herein for illustrative purposes only.

Unless otherwise defined, all technical and scientific terms used herein have the same meaning as commonly understood by those skilled in the art belonging to the field of the present disclosure. The terms used herein in the specification of the disclosure are used only for the purpose of describing specific embodiments and are not intended to limit the disclosure. The term “or/and” as used herein includes any and all combinations of one or more of the relevant listed items.

Some embodiments of the disclosure are described in detail. The following embodiments and features in the embodiments may be combined with each other without conflict.

In order to better understand the contents of this application, some of the technical terms need to be explained.

Battery formation is a key step in the battery manufacturing process. Battery formation process is mainly to activate the positive and negative substances inside the battery through specific charging and discharging methods, so as to improve the comprehensive performance of the battery. In the process of battery formation, a solid electrolyte interface film (SEI film) is formed on the surface of the negative electrode after the formation process. Among them, the SEI film is a passivated thin layer formed at the interface between the carbon negative electrode and the electrolyte phase, which has an important influence on the charging and discharging performance, self-discharging performance and storage performance of the battery.

The purpose of battery formation is not only to activate the chemical reaction inside the battery, but also to improve the charging and discharging performance, self-discharging performance and storage performance. Key factors in the formation process include formation current, voltage, temperature and external pressure, which together affect the formation quality.

### Example of Implementation:

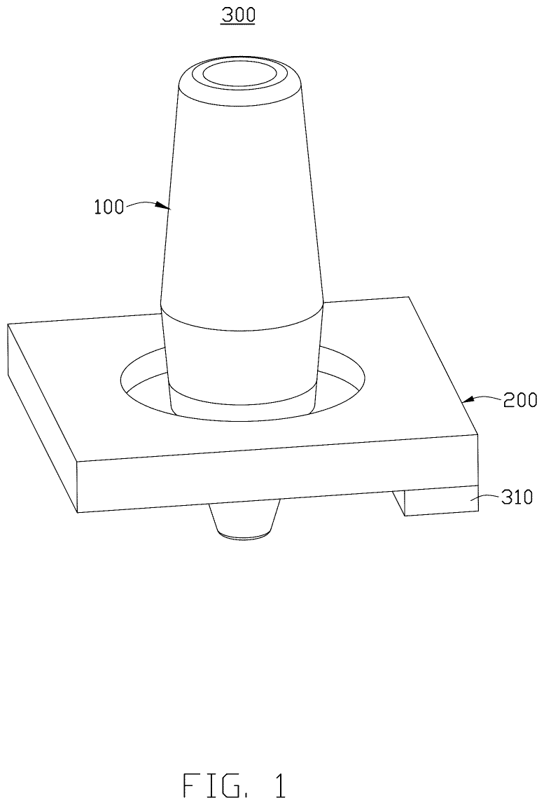

Referring to FIG. 1, the present embodiment provides a battery 300. The battery 300 includes a battery case 200 and a battery assembly 310. In the present embodiment, FIG. 1 illustrates a part of the structure of the battery case 200, and the specific battery case 200 will be described below, and will not be repeated herein. Meanwhile, the number of battery assemblies 310 may be one or more. The one or more battery assemblies 310 are fixed to the case body 210.

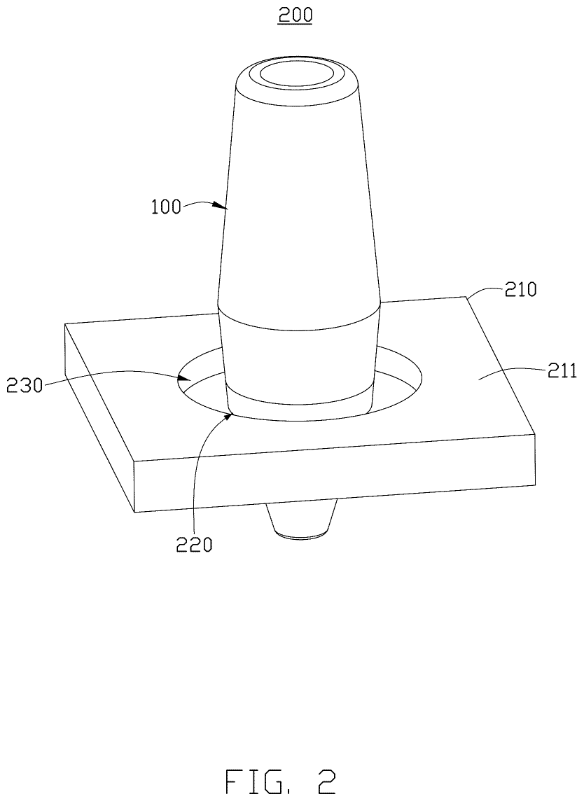

Referring again to FIG. 2, the battery case 200 includes the battery pressure relief device 100 and the case body 210. In this embodiment, the case body 210 in FIG. 2 only shows a partial structure, and the case body 210 may be a case with a hollow interior, and the one or more battery assemblies 310 are fixed to the interior of the case body 210. In other embodiments, the battery case 200 may also be a box of various shapes with a hollow interior, and the present disclosure does not limit this, as long as it is ensured that one or more battery assemblies 310 can be fixed to the interior of the case body 210. Meanwhile, the battery pressure relief device 100 is provided on the case body 210.

During battery formation, the battery assembly 310 will generate a large amount of gas inside the case body 210. Specifically, the case body 210 includes a cover 211, the cover 211 is provided with an exhaust port 220, and a holding space 230 formed by expanding upwardly from the exhaust port 220. The exhaust port 220 is connected to the holding space 230. In this embodiment, the holding space 230 is a stepped hole running through, and the exhaust port 220 and the holding space 230 are coaxially provided. The battery pressure relief device 100 is provided through the exhaust port 220, and a portion of the battery pressure relief device 100 is placed in the holding space 230. The exhaust port 220 is connected to the interior of the battery pressure relief device 100. So that a large amount of gas generated by the battery assembly 310 inside the case body 210 can be vented to the outside world through the exhaust port 220 and the battery pressure relief device 100.

The following will specify the process of how the gas inside the case body 210 is vented to the outside through the exhaust port 220 and the battery pressure relief device 100 when the battery assembly 310 generates a large amount of gas inside the case body 210.

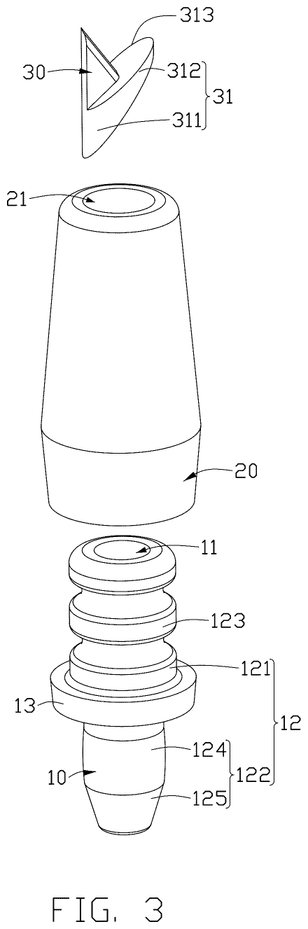

Referring to FIGS. 2 and 3, the battery pressure relief device 100 includes a valve seat 10, a valve body 20 and a spool 30. One end of the valve seat 10 is used to pass through the holding space 230 and the exhaust port 220 and connect to the case body 210, and the other end can be detachably connected to the valve body 20. A first pressure relief passage 11 is provided in the valve seat 10, and a second pressure relief passage 21 is provided in the valve body 20. The first pressure relief passage 11 is connected to the inner space of the case body 210 and the second pressure relief passage 21, respectively. The spool 30 is disposed in the second pressure relief passage 21, with one end of the spool 30 is connected to the valve body 20, and the other end of the spool 20 is a free end 313. The end portion of the free end 313 is capable of pressing against an inner wall of the valve body 20 or away from the inner wall of the valve body 20 when subjected to an external force in a different axial direction.

In this embodiment, the valve body 20 is a cylindrical structure with a hollow interior. The valve body 20 with the cylindrical structure includes a cylindrical cylinder and a conical cylinder. The conical cylinder is formed by extending from one end of the cylindrical cylinder in a direction away from the cylindrical cylinder, and the other end of the cylindrical cylinder away from the conical cylinder is connected to the valve seat 10. A diameter of a portion of the second pressure relief passage 21 disposed inside the conical cylinder is equal to a diameter of the portion of the second pressure relief passage 21 disposed inside the cylindrical cylinder. The spool 30 may be connected to an end face of the end of the valve body 20 away from the valve seat 10, and the spool 30 may also be connected to an inner wall or an outer wall of the second pressure relief passage 21. The present disclosure does not limit the specific location at which the spool 30 is attached to the valve body 20, as long as it is ensured that the spool 30 is able to oscillate relative to the valve body 20 to open or close the second pressure relief passage 21. In other embodiments, the diameter of the portion of the second pressure relief passage 21 disposed inside the conical barrel may be larger than the diameter of the portion of the second pressure relief passage 21 disposed inside the cylindrical barrel. Alternatively, the diameter of the portion of the second pressure relief passage 21 disposed inside the conical barrel may be smaller than the diameter of the portion of the second pressure relief passage 21 disposed inside the cylindrical barrel.

When the battery assembly 310 generates more gas inside the case body 210, the pressure inside the case body 210 is greater than the pressure outside. In order to avoid affecting the quality of the battery assembly 310, it is necessary to discharge the gas inside the case body 210. At this time, the spool 30 is affected by the strong pressure difference between the internal space of the case body 210 and the outside world, the spool 30 can automatically open the second pressure relief passage 21, and the gas inside the case body 210 can be discharged to the outside world in a timely manner through the first pressure relief passage 11, the second pressure relief passage 21 and the exhaust port 220. Conversely, when the gas inside the case body 210 is discharged to the outside world, the pressure in the internal space of the case body 210 is the same as the pressure in the outside world. The spool 30 can automatically close the second pressure relief passage 21 due to its own gravitational tendency to ensure the sealing of the case body 210. In this embodiment, when the difference between the pressure of the internal space of the case body 210 and the pressure of the outside world is greater than or equal to 1 atmospheric pressure, the spool 30 can automatically open the second pressure relief passage 21 so as to allow the case body 210 to relieve pressure.

In some embodiments, the maximum radial distance of the free end 313 of the spool 30 away from the interior of the valve body 20 is at least 0.67 mm. For example, the maximum radial distance of the free end 313 of the spool 30 away from the interior of the valve body 20 may be 0.67 mm, 0.7 mm, 0.85 mm, 1.5 mm, etc., and the present disclosure does not limit the specific value of the maximum value of the radial distance of the free end 313 of the spool 30 away from the interior of the valve body 20.

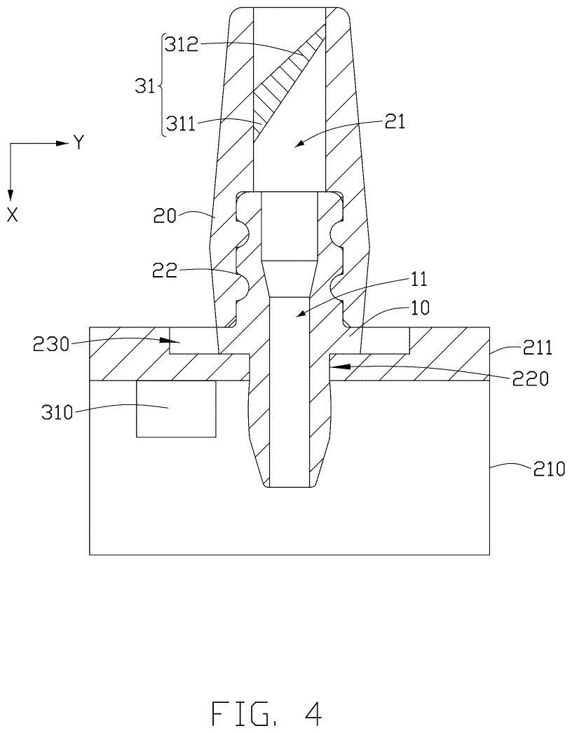

In one embodiment, please refer to FIG. 4, the spool 30 includes a flap 31. The flap 31 includes a connecting segment 311 and a sealing segment 312, and the sealing segment 312 is connected to the connecting segment 311 and extends from the connecting segment 311. The connecting segment 311 is pivotally connected to the valve body 20, and the connecting segment 311 can rotate relative to the valve body 20 so as to drive the sealing segment 312 to swing, so that the sealing segment 312 seals the second pressure relief passage 21 or is away from the second pressure relief passage 21. In this embodiment, the connecting segment 311 and the sealing segment 312 are integrally molded, and the sealing segment 312 extends from the connecting segment 311 in a direction away from the first pressure relief passage 11. The sealing segment 312 is bent up and down in the direction near or away from the first pressure relief passage 11 due to the rotation of the connecting segment 311. In this way, the connecting segment 311 and the sealing segment 312 can cooperate with each other to open the second pressure relief passage 21 or close the second pressure relief passage 21.

In other embodiments, the sealing segment 312 may also extend from the connecting segment 311 in a direction of bending near the side where the first pressure relief passage 11 is located. Moreover, the connecting segment 311 and the sealing segment 312 may not be integrally molded, i.e., the connecting segment 311 is connected to the sealing segment 312; as long as it is ensured that the connecting segment 311 can drive the sealing segment 312 to swing when rotating with respect to the valve body 20, and that the sealing segment 312 is able to seal the second pressure relief passage 21 or move away from the second pressure relief passage 21.

At the same time, the flap 31 may be made of an elastic material, and the elastic material may be, for example, rubber. And the end surface of the sealing segment 312 at the end away from the connecting segment 311 can be completely adhered to the inner wall of the second pressure relief passage 21. It is convenient for the connecting segment 311 to be able to link the sealing segment 312 to oscillate when it rotates with respect to the valve body 20, so that the sealing segment 312 can be resiliently resisted against the inner wall of the second pressure relief passage 21. On the one hand, the sealing segment 312 closely fits the inner wall of the second pressure relief passage 21, thereby ensuring that the flap 31 completely seals the second pressure relief passage 21, and thereby safeguarding the sealing of the interior of the case body 210. On the other hand, the sealing segment 312, which can be swung back and forth, can also avoid damage to the inner wall of the second pressure relief passage 21. The present disclosure does not limit the specific material of the flap 31 as long as it is resilient.

For the spool 30, the present disclosure provides several different designs as follows:

Design 1: As shown in FIG. 4, one end of the connecting segment 311 is pivoted to an inner wall of the second pressure relief passage 21 on one side along the second direction Y, and the sealing segment 312 is pivotable relative to the inner wall of the second pressure relief passage 21 on the other side along the second direction Y to seal the second pressure relief passage 21 or to open the second pressure relief passage 21. Furthermore, the shape of the projection of the flap 31 in the first direction X is the same as the shape of the cross section of the second pressure relief passage 21 along the second direction Y, and the first direction X and the second direction Y are perpendicular to each other.

When it is necessary to exhaust the case body 210, the flap 31 opens the second pressure relief passage 21, and a large amount of gas inside the case body 210 can be discharged to the outside world through the first pressure relief passage 11 and the second pressure relief passage 21. Conversely, when the exhausting is completed, the flap 31 closes the second pressure relief passage 21 to ensure the airtightness of the interior of the case body 210 and the battery pressure relief device 100.

Based on Design 1, the spool 30 can also be improved as follows:

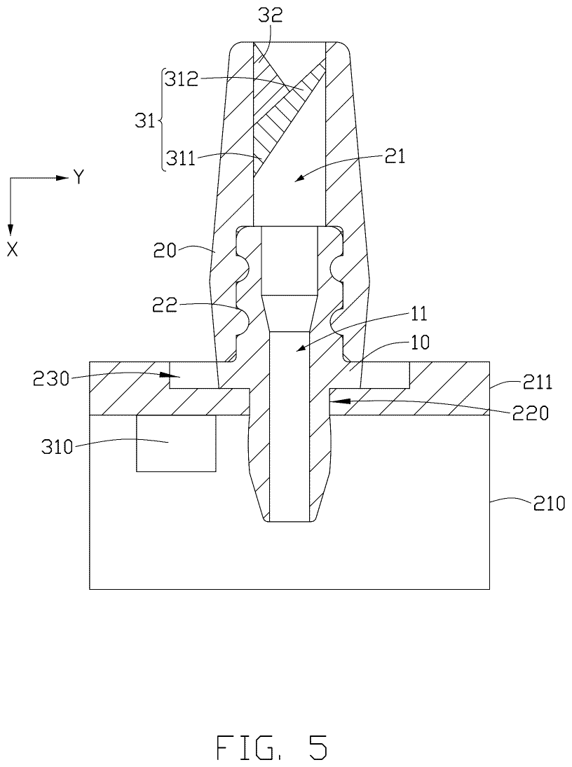

Design 2: Please refer to FIG. 5, the spool 30 also includes a linkage member 32. The linkage member 32 extends from one side of the connecting segment 311 in a direction away from the first pressure relief passage 11, and the linkage member 32 is connected to the inner wall of the second pressure relief passage 21 on the side away from the sealing segment 312.

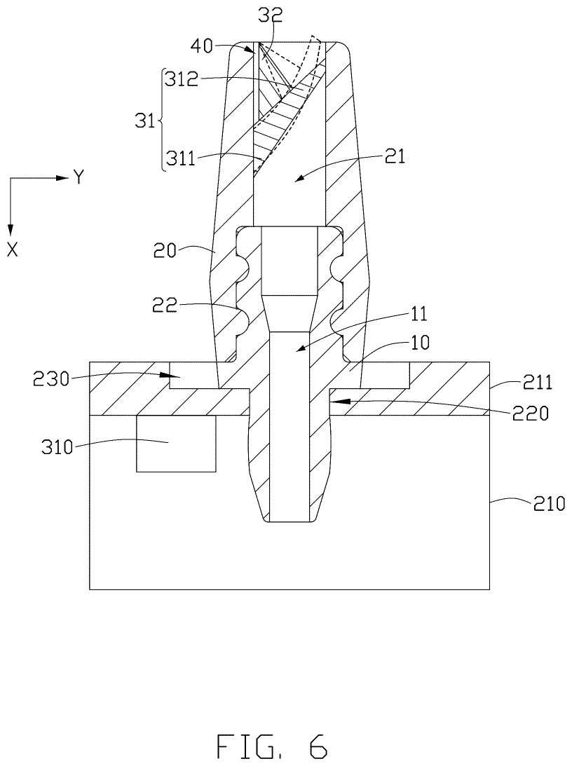

Design 3: Please refer to FIG. 6, the linkage member 32 extends from the side of the connecting segment 311 in a direction away from the first pressure relief passage 11, and a gap 40 is formed between the side of the linkage member 32 away from the sealing segment 312 and the valve body 20.

In this embodiment, when it is necessary to vent the case body 210, the sealing segment 312 swings in a direction away from the first pressure relief passage 11, thereby driving the linkage member 32 in a direction close to the gap 40. In this way, the sealing segment 312 opens the second pressure relief passage 21, and the gas inside the case body 210 can be discharged to the outside world through the first pressure relief passage 11 and the second pressure relief passage 21. When the sealing segment 312 opens the second pressure relief passage 21, the presence of the gap 40 prevents the flap 31 and the linkage member 32 from being damaged by the breaking force of the pressure difference between the inside of the case body 210 and the outside world.

In this embodiment, the shape of the linkage member 32 is a triangular column. That is, one side of the linkage member 32 is connected to the connecting segment 311 and the other side is connected to the inner wall of the second pressure relief passage 21. Alternatively, one side of the linkage member 32 connects the connecting segment 311, and the other side forms a gap 40 between the linkage member 32 and the inner wall of the second pressure relief passage 21. In other embodiments, the shape of the linkage member 32 may be other shapes, such as rectangular, square, or the like. The present disclosure does not limit the shape of the linkage member 32.

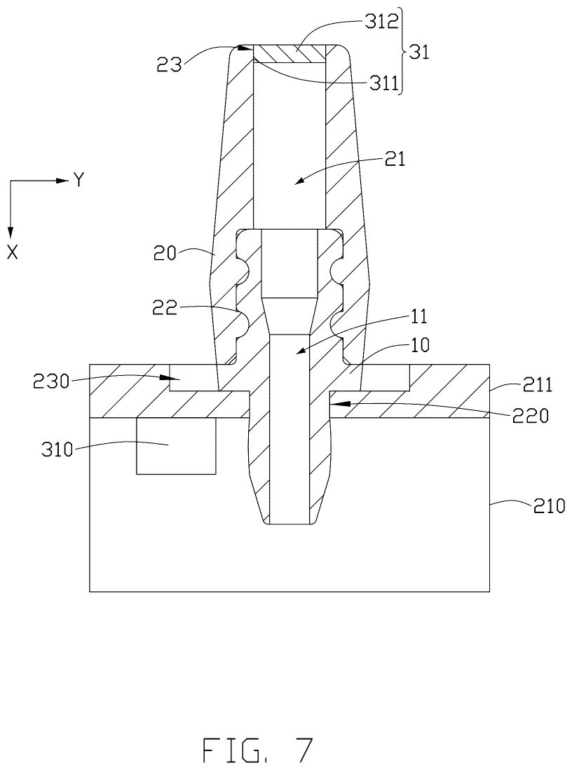

Design 4: As shown in FIG. 7, the valve body 20 is provided with an opening 23, which is located at one end of the valve body 20 away from the valve seat 10, and the opening 23 is connected to the second pressure relief passage 21. The connecting segment 311 is connected to the valve body 20, and the sealing segment 312 can be oscillated relative to the valve body 20 to open the opening 23 or to close the opening 23. Furthermore, the shape of a projection of the flap 31 along the first direction X is same to the shape of a cross section of the second pressure relief passage 21 along the second direction Y, and the first direction X and the second direction Y are perpendicular to each other.

Based on Design 4, the spool 30 can also be improved as follows:

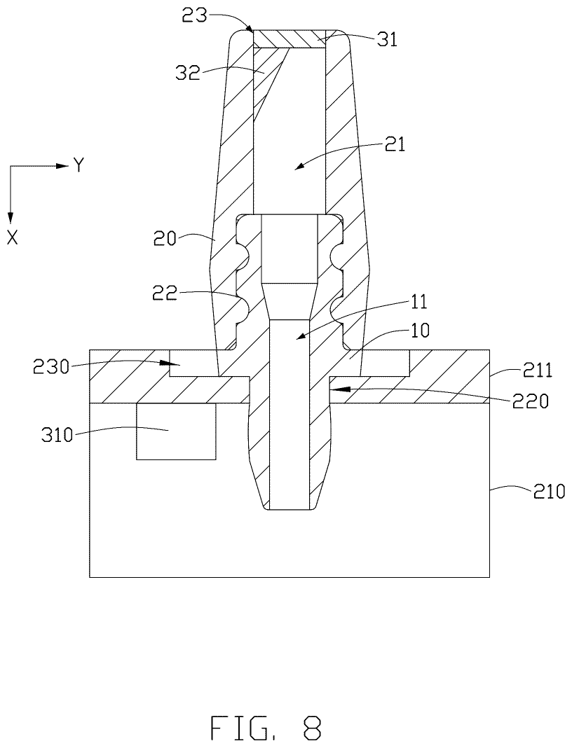

Design 5: Please refer to FIG. 8, the spool 30 also includes a linkage member 32. The linkage member 32 extends from one side of the connecting segment 311 in a direction close to the first pressure relief passage 11, and the side of the linkage member 32 away from the sealing segment 312 connects to the inner wall of the second pressure relief passage 21.

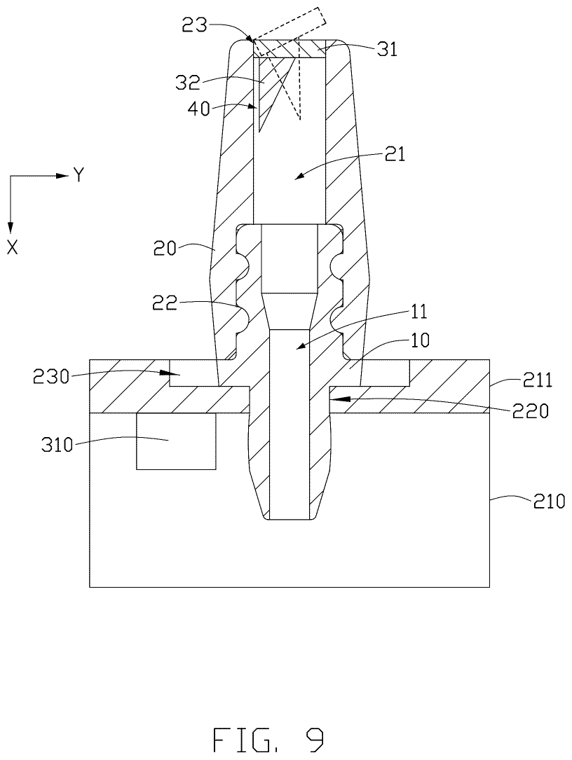

Design 6: Referring to FIG. 9, the linkage member 32 extends from the side of the connecting segment 311 in a direction close to the first pressure relief passage 11, and a gap 40 is formed between the side of the linkage member 32 away from the sealing segment 312 and the valve body 20. The gap 40 connects to the second pressure relief passage 21.

Providing the linkage member 32 on one side of the connecting segment 311 has at least the following beneficial effects: on the one hand, when it is necessary to ventilate the case body 210, it is convenient for the sealing segment 312 to quickly bend at the connection point with the connecting segment 311 in order to open the opening 23; on the other hand, when the venting is completed, the linkage member 32 pulls the flap 31 due to its own gravitational force in the direction of the direction close to the side on which the first relief channel 11 is located, so that the flap 31 quickly closes the opening 23 to ensure the sealing of the case body 210.

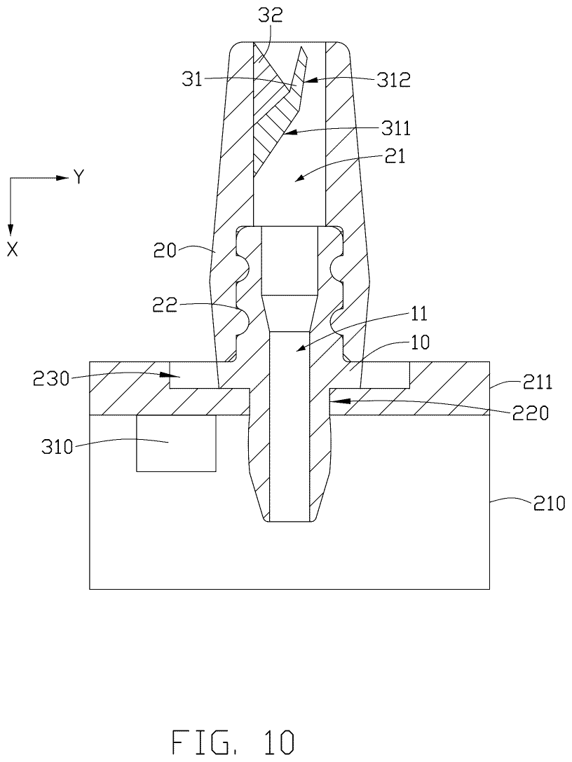

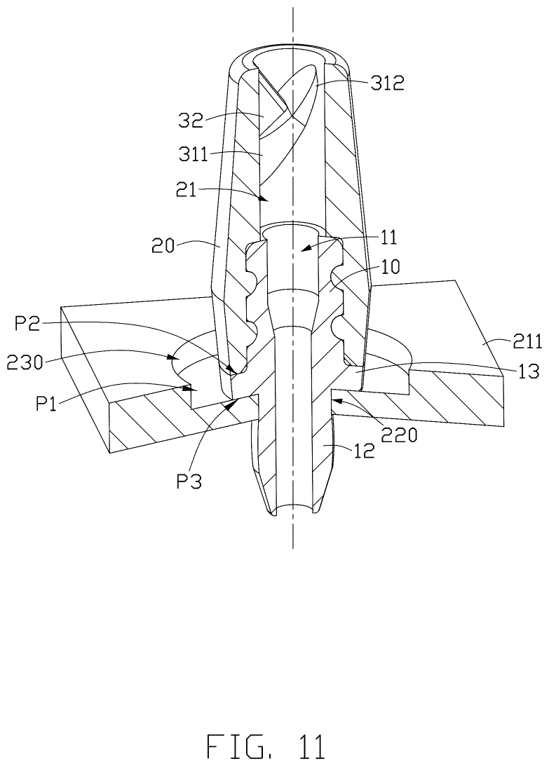

Specifically, please combine FIGS. 10 and 11, when the battery 300 is formed, the battery assembly 310 generates a large amount of gas in the interior of the case body 210, and when the internal pressure of the case body 210 is greater than the external pressure, it is proved that the internal pressure of the case body 210 is greater than the external pressure, and at this time, the battery pressure relief device 100 is in a state of exhausting gas. Since there is a pressure difference between the internal space of the case body 210 and the outside world, the connecting segment 311 rotates relative to the valve body 20 to drive the sealing segment 312 to swing, thus opening the second pressure relief passage 21. In this way, a large amount of gas inside the case body 210 is discharged to the outside world through the first pressure relief passage 11 and the second pressure relief passage 21 inside the valve seat 10.

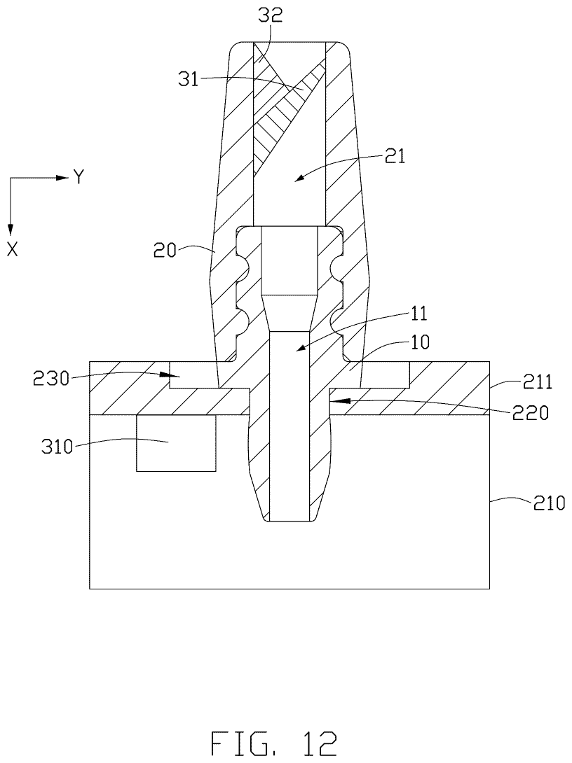

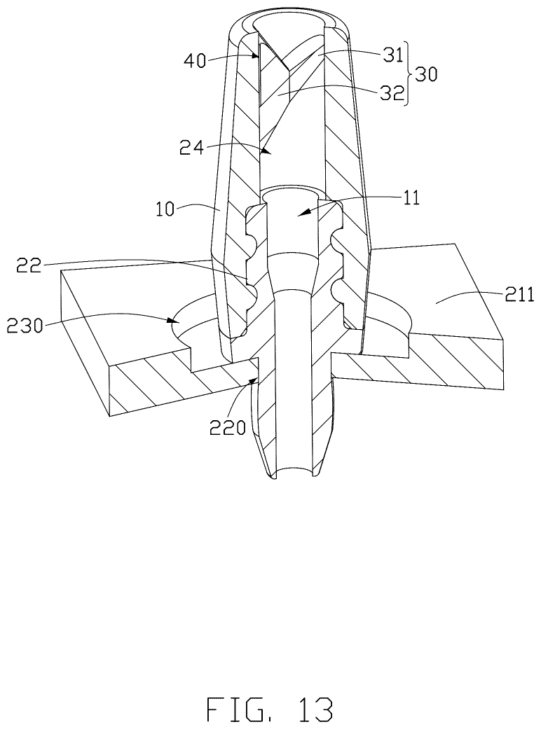

Please combine FIGS. 12 and 13, the battery pressure relief device 100 is in a normal state when the gas inside the case body 210 is discharged to the outside world is completed, and at this time, the pressure inside the case body 210 is the same as the outside world pressure. The spool 30 is prompted to oscillate relative to the valve body 20 under its own gravitational tendency, so that the spool 30 closes the second pressure relief passage 21 to ensure the sealing of the inside of the case body 210, and to avoid the outside air and dust and other impurities to enter into the inside of the battery 300, preventing the electrolyte of the battery 300 from being contaminated and affecting the performance of the battery 300.

In some embodiments, referring again to FIG. 11, the valve seat 10 includes a seat body 12 and a support member 13, the support member 13 is provided on the outside of the seat body 12, and the first pressure relief passage 11 passes through the seat body 12 and the support member 13. One end of the seat body 12 connects to the valve body 20, and the other end passes through the exhaust port 220 and the holding space 230 and connects to the case body 210. The support member 13 is disposed between the cover 211 and the valve body 20, and the he support member 13 is held in contact with the cover 211 and the valve body 20, respectively. In this embodiment, the seat body 12 and the support member 13 may be integrally molded and the support member 13 is disposed around the periphery of the seat body 12.

Specifically, the holding space 230 has a hole bottom surface P1. The support member 13 has a first surface P2 and a second surface P3, with the first surface P2 and the second surface P3 disposed opposite each other. The first surface P2 is disposed at an end of the support member 13 proximate the valve body 20, and the first surface P2 abuts an end face of the end of the valve body 20. The second surface P3 abuts the hole bottom surface P1 when the valve seat 10 penetrates the exhaust port 220 and the holding space 230.

It is noted that the diameter of the exhaust port 220 is smaller than the diameter of the support member 13. In this way, the support member 13 is used to support the cover 211 and the valve body 20 when one end of the seat body 12 penetrates the exhaust port 220 and the holding space 230 and connects to the cover 211. At the same time, the battery pressure relief device 100 is securely attached to the cover 211.

Furthermore, in conjunction with FIGS. 3 and 4, the seat body 12 includes a first seat 121 and a second seat 122, the first seat 121 and the second seat 122 are disposed opposite each other. One end of the support member 13 is connected to the first seat 121, and the other end is connected to the second seat 122. The first seat 121 is located on a side of the support member 13 near the second pressure relief passage 21, and the second seat 122 is located on a side of the support member 13 away from the second pressure relief passage 21. The first seat 121 is removably connected to the valve body 20, and the second seat 122 is removably connected to the cover 211.

Specifically, in this embodiment, the outer peripheral side of the first seat 121 is provided with an external thread 123, the inner wall of the second pressure relief passage 21 is provided with an internal thread 22, and the external thread 123 is threadedly connected to the internal thread 22. When the battery pressure relief device 100 needs to be cleaned, the threaded connection between the valve seat 10 and the valve body 20 makes it easy for the user to quickly disassemble the valve seat 10 and the valve body 20; the valve body 20 and the seat body 12 are then cleaned separately to ensure that the interiors of the first pressure relief passage 11 and the second pressure relief passage 21 are free of impurities so as not to interfere with the discharging of gases from the interior of the case body 210. When the cleaning of the valve body 20 and the seat body 12 are completed, the valve body 20 and the seat body 12 can be connected. The reusability of the battery pressure relief device 100 has improved.

In some embodiments, the second seat 122 includes a connecting portion 124 and a guiding portion 125, with one end of the connecting portion 124 connecting to the support member 13 and the other end connecting to the guiding portion 125. In this embodiment, the diameter of the guiding portion 125 tapers in a direction from one end of the connecting portion 124 away from the connecting portion 124.

It will be appreciated that the diameter of the guide portion 125 is designed to taper in a direction from one end of the connecting portion 124 away from the connecting portion 124, with the diameter of the support member 13 being greater than the diameter of the connecting portion 124. The diameter of the exhaust port 220 is equal to the diameter of the connecting portion 124. When it is necessary to connect the battery pressure relief device 100 to the cover 211, the guide portion 125 is passed through the exhaust port 220 and the holding space 230 so that the connecting portion 124 is placed in the exhaust port 220. The hole bottom surface P1 of the support member 13 fits against the second surface P3. In this way, the second seat 122 is securely connected to the cover 211.

It should be noted that the materials of the valve seat 10 and the valve body 20 are both made of resilient materials. On the one hand, because the second seat 122 is resilient, the resilient second seat 122 avoids damaging the exhaust port 220 when the second seat 122 is placed at the exhaust port 220 for connecting to the cover 211. On the other hand, damage to the valve seat 10 and the valve body 20 is avoided when the valve seat 10 and the valve body 20 are disassembled. On the other hand, because of the pressure difference between the pressure inside the case body 210 and the outside pressure difference, the flap 31 avoids breakage of the flap 31 when opening or closing the second pressure relief passage 21. The present disclosure does not limit the specific type of elastomeric material. For example, the elastic material may be a material such as rubber; it is sufficient to ensure that the battery pressure relief device 100 is elastic.

In the battery pressure relief device 100 shown in FIGS. 3 to 13, when the battery pressure relief device 100 is used to relieve pressure inside the case body 210, on the one hand, the spool 30 is provided inside the second pressure relief passage 21, which not only allows the spool 30 to detach the inner wall of the second pressure relief passage 21 to discharge the gas inside the case body 210 to the outside world when pressure relief inside the case body 210 is required, but also block outside air and dust from entering the interior of the case body 210. On the other hand, the valve seat 10 and the valve body 20 are removably connected to each other, so that when it is necessary to clean the battery pressure relief device 100, the valve seat 10 and the valve body 20 are disassembled and then cleaned, and the reuse rate of the battery pressure relief device 100 is increased. On another hand, the inner diameter of the connecting portion 124 is provided to be smaller than the inner diameter of the guiding portion 125, so as to facilitate mounting of the battery pressure relief device 100 to the case body 210. The problem of the battery expanding to affect the service life of the battery or to cause a safety hazard such as an explosion, which exists when a large amount of gases generated by the battery during the formation of the battery are not discharged from the outside world in a timely manner, is avoided.

The above embodiments are only used to illustrate the technical solutions of the disclosure and are not intended to be limiting, although the disclosure has been illustrated in detail with reference to the above preferred embodiments, a person of ordinary skill in the art should understand that may modify the technical solutions of the disclosure or make equivalent substitutions without departing from the spirit and scope of the technical solutions of the disclosure.

What is claimed is:

1. A battery pressure relief device to relieve pressure from a battery, the battery pressure relief device comprising:
a valve seat comprising a first pressure relief passage;
a valve body comprising a second pressure relief passage, wherein the valve seat is removably connected to the valve body, the first pressure relief passage is connected to the second pressure relief passage; and
a spool provided in the second pressure relief passage,
wherein, an end of the spool is connected to the valve body, another end of the spool is a free end, an end portion of the free end is pressed against or pulled away from an inner wall of the valve body when the end portion is subject to axial external forces.

2. The battery pressure relief device of claim 1, wherein the free end is pulled away from the inner wall of the valve body when a difference between a pressure in an inner space of the valve body and a pressure exterior to the battery pressure relief device is greater than or equal to 1 atmosphere.

3. The battery pressure relief device of claim 1, wherein a maximum radial distance of the free end pulled away from the inner wall of the valve body is at least 0.67 mm.

4. The battery pressure relief device of claim 1, wherein the spool comprises a flap, the flap comprises a connecting segment and a sealing segment, the sealing segment is connected to and extends from the connecting segment, the connecting segment is pivotally coupled to the valve body, and the connecting segment rotatable with respect to the valve body, when the connecting segment rotates, the connecting segment drives the sealing segment to swing, the second pressure relief passage is sealed or opened by the sealing segment.

5. The battery pressure relief device of claim 4, wherein the connecting segment is pivotally coupled to the valve body by an end of the connecting segment pivotally connected to an inner wall or an outer wall of a side of the second pressure relief passage, and the connecting segment further drives the sealing segment to oscillate relative to an inner wall of another side of the second pressure relief passage to seal or open the second pressure relief passage.

6. The battery pressure relief device of claim 4, wherein the spool further comprises a linkage member;
the linkage member extends from a side of the connecting segment in a direction away from the first pressure relief passage, the linkage member is connected to an inner wall, of the second pressure relief passage, on a side away from the sealing segment; or, the linkage member extends from a side of the connecting segment in a direction away from the first pressure relief passage, the linkage member forms a gap between a side of the sealing segment away from the sealing segment and the valve body, the gap is in communication with the second pressure relief passage.

7. The battery pressure relief device of claim 1, wherein the valve seat comprises a seat body and a support member, the support member is mounted outside the seat body, the first pressure relief passage passes through the seat body and the support member, the seat body is connected to the valve body; the seat body comprises a first seat and a second seat, the first seat and the second seat are disposed opposite to each other; an end of the support member is connected to the first seat, and another end of the support member is connected to the second seat; the first seat is located on a side of the support member close to the second pressure relief passage, and the second seat is located on a side of the support member away from the second pressure relief passage, the first seat is detachably connected to the valve body.

8. A battery case comprising a case body and a battery pressure relief device, the battery pressure relief device comprising:
a valve seat comprising a first pressure relief passage;
a valve body comprising a second pressure relief passage, wherein the valve seat is removably connected to the valve body, the first pressure relief passage is connected to the second pressure relief passage; and
a spool provided in the second pressure relief passage,
wherein, an end of the spool is connected to the valve body, another end of the spool is a free end, an end portion of the free end is pressed against or pulled away from an inner wall of the valve body when the end portion is subject to axial external forces;
Wherein, the battery pressure relief device is provided on the case body, the case body is provided with an exhaust port, and a portion of the battery pressure relief device is threaded through the exhaust port into the interior of the case body, the interior of the case body being connected to the first pressure relief passage and the second pressure relief passage.

9. The battery case of claim 8, wherein the free end is pulled away from the inner wall of the valve body when a difference between a pressure in an inner space of the valve body and a pressure exterior to the battery pressure relief device is greater than or equal to 1 atmosphere.

10. The battery case of claim 8, wherein a maximum radial distance of the free end pulled away from the inner wall of the valve body is at least 0.67 mm.

11. The battery case of claim 8, wherein the spool comprises a flap, the flap comprises a connecting segment and a sealing segment, the sealing segment is connected to and extends from the connecting segment, the connecting segment is pivotally coupled to the valve body, and the connecting segment rotatable with respect to the valve body, when the connecting segment rotates, the connecting segment drives the sealing segment to swing, the second pressure relief passage is sealed or opened by the sealing segment.

12. The battery case of claim 11, wherein the connecting segment is pivotally coupled to the valve body by an end of the connecting segment pivotally connected to an inner wall or an outer wall of a side of the second pressure relief passage, and the connecting segment further drives the sealing segment to oscillate relative to an inner wall of another side of the second pressure relief passage to seal or open the second pressure relief passage.

13. The battery case of claim 11, wherein the spool further comprises a linkage member;
the linkage member extends from a side of the connecting segment in a direction away from the first pressure relief passage, the linkage member is connected to an inner wall, of the second pressure relief passage, on a side away from the sealing segment; or, the linkage member extends from a side of the connecting segment in a direction away from the first pressure relief passage, the linkage member forms a gap between a side of the sealing segment away from the sealing segment and the valve body, the gap is in communication with the second pressure relief passage.

14. The battery case of claim 8, wherein the valve seat comprises a seat body and a support member, the support member is mounted outside the seat body, the first pressure relief passage passes through the seat body and the support member, the seat body is connected to the valve body; the seat body comprises a first seat and a second seat, the first seat and the second seat are disposed opposite to each other; an end of the support member is connected to the first seat, and another end of the support member is connected to the second seat; the first seat is located on a side of the support member close to the second pressure relief passage, and the second seat is located on a side of the support member away from the second pressure relief passage, the first seat is detachably connected to the valve body.

15. A battery comprising a battery case and a battery assembly provided inside the battery case, the battery case comprising a case body and a battery pressure relief device, the battery pressure relief device comprising:
a valve seat comprising a first pressure relief passage;
a valve body comprising a second pressure relief passage, wherein the valve seat is removably connected to the valve body, the first pressure relief passage is connected to the second pressure relief passage; and
a spool provided in the second pressure relief passage,
wherein, an end of the spool is connected to the valve body, another end of the spool is a free end, an end portion of the free end is pressed against or pulled away from an inner wall of the valve body when the end portion is subject to axial external forces;
Wherein, the battery pressure relief device is provided on the case body, the case body is provided with an exhaust port, and a portion of the battery pressure relief device is threaded through the exhaust port into the interior of the case body, the interior of the case body being connected to the first pressure relief passage and the second pressure relief passage.

16. The battery of claim 15, wherein the free end is pulled away from the inner wall of the valve body when a difference between a pressure in an inner space of the valve body and a pressure exterior to the battery pressure relief device is greater than or equal to 1 atmosphere.

17. The battery of claim 15, wherein a maximum radial distance of the free end pulled away from the inner wall of the valve body is at least 0.67 mm.

18. The battery of claim 15, wherein the spool comprises a flap, the flap comprises a connecting segment and a sealing segment, the sealing segment is connected to and extends from the connecting segment, the connecting segment is pivotally coupled to the valve body, and the connecting segment rotatable with respect to the valve body, when the connecting segment rotates, the connecting segment drives the sealing segment to swing, the second pressure relief passage is sealed or opened by the sealing segment.

19. The battery of claim 18, wherein the connecting segment is pivotally coupled to the valve body by an end of the connecting segment pivotally connected to an inner wall or an outer wall of a side of the second pressure relief passage, and the connecting segment further drives the sealing segment to oscillate relative to an inner wall of another side of the second pressure relief passage to seal or open the second pressure relief passage.

20. The battery of claim 18, wherein the spool further comprises a linkage member;
the linkage member extends from a side of the connecting segment in a direction away from the first pressure relief passage, the linkage member is connected to an inner wall, of the second pressure relief passage, on a side away from the sealing segment; or, the linkage member extends from a side of the connecting segment in a direction away from the first pressure relief passage, the linkage member forms a gap between a side of the sealing segment away from the sealing segment and the valve body, the gap is in communication with the second pressure relief passage.

21. The battery of claim 15, wherein the valve seat comprises a seat body and a support member, the support member is mounted outside the seat body, the first pressure relief passage passes through the seat body and the support member, the seat body is connected to the valve body; the seat body comprises a first seat and a second seat, the first seat and the second seat are disposed opposite to each other; an end of the support member is connected to the first seat, and another end of the support member is connected to the second seat; the first seat is located on a side of the support member close to the second pressure relief passage, and the second seat is located on a side of the support member away from the second pressure relief passage, the first seat is detachably connected to the valve body.
